(19) United States
(12) Patent Application Publication
(10) Pub. No.: US 2011/0145017 A1
(43) Pub. Date: Jun. 16, 2011

(54) SYSTEM AND METHOD FOR PROVIDING INFORMATION REGARDING A MEDICATION

(76) Inventor: Ken Beng Chye Lee, New South Wales (AU)

(21) Appl. No.: 12/994,902

(22) PCT Filed: May 28, 2009
(86) PCT No.: PCT/AU2009/000665

§ 371 Date: Feb. 25, 2011

Related U.S. Application Data
(62) Division of application No. 61/076,911, filed on Jun. 30, 2008.

(30) Foreign Application Priority Data
May 29, 2008 (AU) 2008902693

(51) Int. Cl. G06Q 50/00

(52) U.S. Cl. 705/3

(57) ABSTRACT

A system and method for providing information regarding a medication comprising the steps of, retrieving data, associated with the medication, generating a checklist on the basis of the retrieved data, wherein the checklist is arranged with at least one item for checking with a patient.

### TECHNICAL FIELD

The present invention relates to a system and method for providing information regarding a medication, and particularly, although not exclusively, provides a system and method for providing targeted information to a patient.

### BACKGROUND INVENTION

A patient may consult a pharmacist for advice on the properties of a medication. As part of the consultation, the pharmacist may provide the patient with some information relating to the usage of the medication. In some situations, the consultation process simply involves the provision of generic information regarding the medication, relying on the patient to read or understand the properties and the correct usage of the medication.

To assist the patient in understanding the properties of the medication, the pharmacist may speak with the patient in order to determine particular attributes of the patient. Using this information, the pharmacist can provide more targeted advice based on their knowledge of pharmacology and patient care.

However, in these situations, the pharmacist may be unable to convey accurate advice relating to the medication due to the lack of medical history or information relating to the patient. A pharmaceutical manufacturer is also unable to gain access to specific reactions or effects that a patient may experience after the prescription of the medication.

### SUMMARY OF THE INVENTION

In accordance with a first aspect, the present invention provides a method for providing information regarding a medication comprising the steps of retrieving data associated with the medication, generating a check list on the basis of the retrieved data, wherein the check list is arranged with at least one item for checking with a patient.

In an embodiment of the first aspect the method comprises the further step of retrieving patient details before generating the check list, the details disclosing at least one characteristic of the patient prescribed with the medication.

At least an embodiment of the invention has the advantage that the system will be able to produce a checklist for a pharmacist to check off any specific items of advice which will need to be conveyed to the patient during the consultation. As the checklist is generated by utilising stored data associated with any specific medication, the checklist can bring to certain properties of the medication which may deserve specific attention for the patient.

By utilising this checklist the pharmacist can ensure that certain aspects of the consumption of this medication can be properly advised to the patient through a consultation process.

In some embodiments where the patient provides information concerning their characteristics including their medical history, the pharmacist is able to generate this checklist further incorporating specific medication properties relevant to the medical history of the patient. This checklist can assist the pharmacist in providing a comprehensive advice to the patient as the checklist will include items which are adapted for the specific patient and their characteristics.

In an embodiment, the checklist is generated by comparing associations between the retrieved data and the patient details, the checklist having the at least one item arranged to provide information concerning the medication associated with the at least one characteristic of the patient.

In an embodiment, the method further comprises the step of providing further information regarding the patient, wherein if the further information affects the consumption of the medication, the further information enables the checklist to be updated with further items for checking with the patient.

In an embodiment, each item is a warning or caution.

In an embodiment, the warning concerns a dosage of the medication.

In an embodiment, the warning concerns at least one effect or interaction of the medication.

In an embodiment, the characteristic is an attribute of the patient.

In an embodiment, the attribute is one of age, gender, weight, race, demographic classification or medical condition.

In accordance with a second aspect, the present invention provides a method for storage data comprising the steps of identifying at least one property of the medication from the retrieved data, identifying at least one attribute of the patient relating to the property of the medication, and associating each of the at least one property of the medication with each the at least one attribute of the patient.

In an embodiment of the second aspect of the present invention, the data is stored at a remote location.

In an embodiment, the data is accessible to an external party.

In an embodiment of the second aspect of the present invention, the method further comprises the step of collecting feedback, the feedback being stored with the data to assist with the generation of the checklists.

In accordance with a third aspect, the present invention provides a system for providing information regarding a medication comprising, a processor arranged to retrieve data associated with the medication, a routine arranged to generate a checklist on the basis of the retrieved data, wherein the checklist is arranged with at least one item for checking with a patient.

### BRIEF DESCRIPTION OF THE DRAWINGS

Embodiments of the present invention will now be described, by way of example, with reference to the accompanying drawings in which:

FIG. 1 is a block diagram of a system in accordance with one embodiment of the present invention;

FIG. 2 is a diagram illustrating operation of the system of FIG. 1;

FIG. 3 is a diagram illustrating operation of the system in accordance with the embodiment of FIG. 1;

FIG. 4 illustrate examples of a checklist as presented by an interface during operation of the system of FIG. 1; and,

FIGS. 5A to 5C illustrate examples of screenshots presented on the interface during operation of the system of FIG. 1.

### DETAILED DESCRIPTION OF THE PREFERRED EMBODIMENT

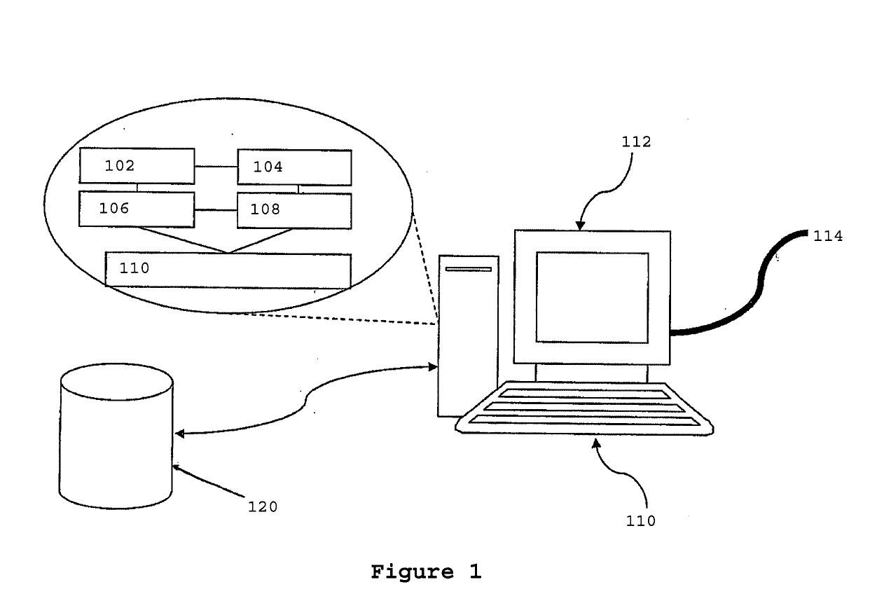

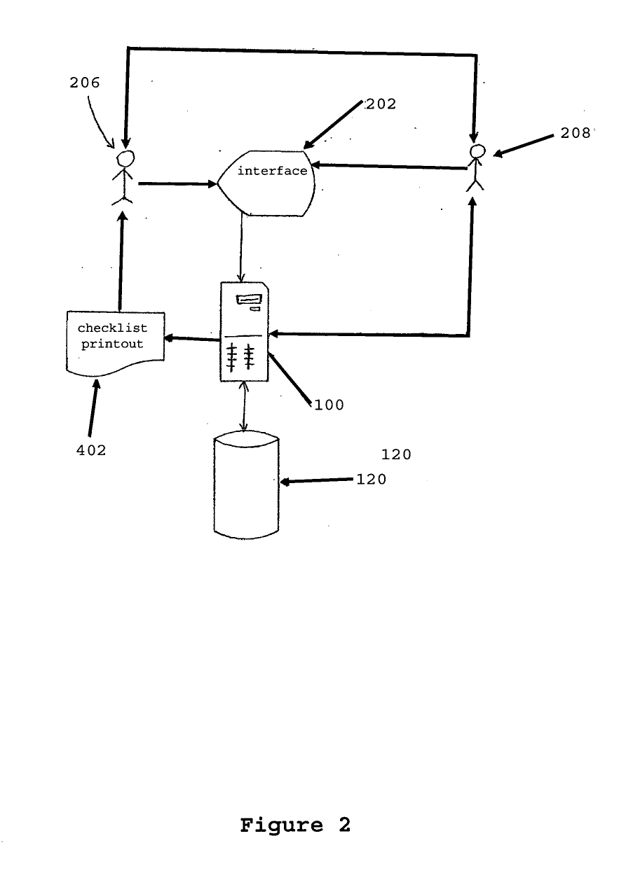

Referring to FIGS. 1 and 2, an embodiment of the present invention is illustrated. This embodiment is arranged to provide a method for providing information regarding a medication, comprising the steps of retrieving data associated with the medication, generating a checklist on the basis of the retrieved data, wherein the checklist is arranged with at least one item for checking with a patient. In this example embodiment, the interface 202 and processor are implemented by a computer system 100. The computer may be implemented by any computing architecture, including stand-alone PC, client/server architecture, “dumb” terminal/mainframe architecture, or any other appropriate architecture. The computing device is appropriately programmed to implement an embodiment of the invention.

In this embodiment, the computer 100 is connected via a communication link to a database remote to the computer hardware. The computer 100 may access a separately administered database 120 containing data associated with a medication, in order to generate a checklist arranged with at least one item for checking with a patient.

In an alternative embodiment, the database 120 may not be separately administered and may be administered within the local computer system 100.

Referring to FIG. 1 there is a shown a schematic diagram of a central transfer system which in this embodiment comprises a server 100. The server 100 comprises suitable components necessary to receive, store and execute appropriate computer instructions. The components may include a processing unit 102, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114. The server 100 includes instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices. At least one of a plurality of communications link may be connected to an external computing network through a telephone line or other type of communications link.

The server 100 may include storage devices such as a disk drive 108 which may encompass solid state drives, hard disk drives, optical drives or magnetic tape drives. The server 100 may use a single disk drive or multiple disk drives. The server 100 may also have a suitable operating system 116 which resides on the disk drive or in the ROM of the server 100.

The system has a database 120 residing on a disk or other storage device which is arranged to store data associated with a medication. The database 120 is in communication with an interface 202, which is implemented by computer software residing on the server 100. The interface 202 provides a platform by which a pharmacist 208 or patient 206 can interact with the system. In one example the pharmacist 208 can enter the patient details into the interface 202 as well as an identifier for the medication which the patient has been prescribed. This information can be entered by the pharmacist 208 through a traditional input device such as a keyboard, or a scanner arranged to read the barcode of a prescription belonging to the patient. Once this information is entered into the interface 202, the information can then be used by the processor to query the database 120 to retrieve data associated with the medication and proceed to generate the checklist 402 for checking with a patient 206.

With reference to FIG. 2, the server 100 has an interface 202 arranged to interact with a pharmacist 208 or a patient 206. The interface 202 has a series of data entry fields adapted for the pharmacist 208 or patient 206 to enter in patient details into the interface 202 and an identifier of the medication which the patient has been prescribed with. The data entry fields are a series of input boxes with specific labels which identify the required information from the patient 206. In some examples, the interface has a complementary scanner or input device such as a smart card reader arranged to read computer instructions in the form of a barcode or smart card data belonging to a patient.

The patient details entered by the patient or pharmacist include attributes which would describe the characteristics of the patient. These may include basic attributes such as, age, weight, gender or ethnicity as well as more advanced attributes such as;
medical condition (including blood pressure, organ function, results of pathology examinations or known illnesses);
medical history (past treatments);
current medical treatments;
lifestyle factors (e.g. vegetarian, alcohol consumption);
allergies; and
genetic profiles.

Once this information has been entered into the interface 202, the information is then stored in the database 120 for future reference. The interface will initiate a write command to the database and record the patient details into a patient table. In situations where a patient record already exists on the database 120, the attributes of the patient can be retrieved whereupon the name or identifier of the patient is entered into the interface 202.

Once the patient details are saved in the system, the server 100 can trigger a processor to execute a query utilizing the identifier of the medication on the database 120 to retrieve data associated with the specific medication the patient has been prescribed. The processor is arranged to execute specific processes implemented in machine or computer code and the processor, in this example, is a computing device having a combination of hardware and software components to execute optical, electronic or computer instructions. By executing the query with the database 120, data stored within the database 120 describing the properties of the medication is retrieved, these properties include, without limitations:
the chemical nature of the medication;
the pharmacological nature of the medication;
the manner in which the medication is to be prescribed;
the reaction of the medication with a patient;
the reaction of the medication with known chemical variables, such as alcohol or food;
the reaction of the medication with other medications;
the dosage and concentration of the medication;
the form of the medication; and
the mode of delivery of the medication.

Once the properties of the medication are retrieved from the database, the properties are then stored within a buffer accessible to the processor. The processor then initiates a checklist generation process, which incorporates the properties of the medication and the patient details to generate a checklist.

The checklist generation process initiates a comparison between each property of the medication with each characteristic of the patient. The comparison begins by comparing each of two variable fields, with one field storing the property of the medication and the other field storing an attribute of the patient. By comparing the two fields, a correlation can be established if the two fields return a match between the property of the medication and the attribute of the patient. This correlation would indicate that the characteristic of the patient would affect the consumption of the medication due to a specific property of the medication. In one example, as implemented on the basis of the structure of the database 120, each property of the medication is sorted with a specific metadata field which would identifier relevant patient attributes that would trigger a correlation.

For example, a prescribed medication used to treat migraines has a specific chemical property rendering it not suitable for pregnant women. In this implementation, a metadata field associated with this medication stores data to indicate that this medication is not suitable for women who are pregnant. In this example, the generation process identifies the metadata field and compares it with the patient details. If the patient attributes indicate the patient is pregnant, the checklist generation process will identify this correlation and produce a check item 412 which is arranged to identify certain risks and warnings which should be provided to a patient before consumption of the medication.

Other examples of implementing the checklist generation process are possible and it will be appreciated that a person skilled in the art may be aware of different implementations of the same inventive concept based on the hardware/software requirements of a user, as well as the structure of the data associated with the medication in the database 120.

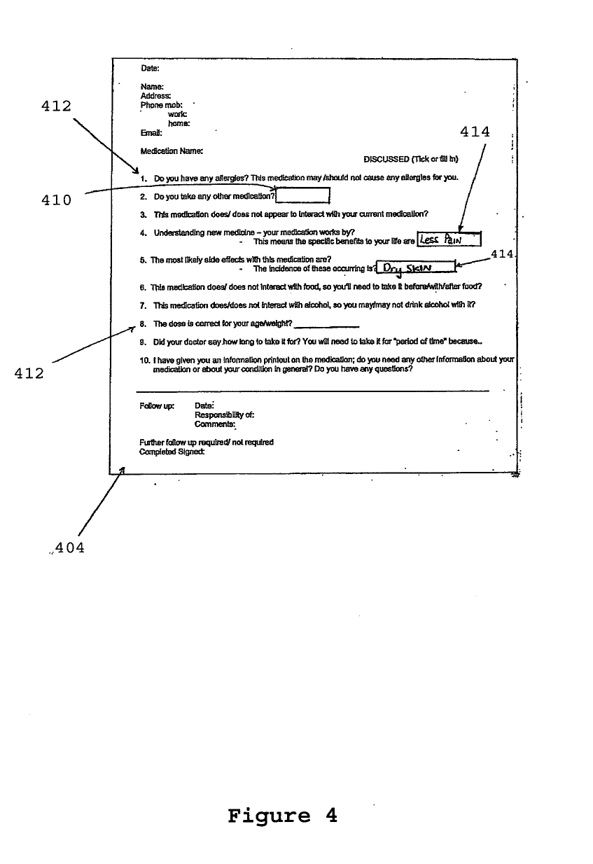

Once the process generates a list of check items 412, the check items 412 are then arranged on a list to form a checklist 404, an example of which is illustrated in FIG. 4. During this process, the processor may add extra text or data into the checklist 404 that may be relevant to the patient or the medication prescribed. This is done by checking a scripting engine arranged to add additional text 414 to each check item 412 to enhance its readability or supplement the check items 412 with medication data, warnings on consumption or legal disclaimers. This will assist the pharmacist 208 in consulting the patient 206 with the checklist 404 as additional relevant information may allow the pharmacist 208 to query for further information from the patient 206.

The processor then compiles each check item 412 to form a complete checklist 404, which is then displayed onto the interface 202 for the pharmacist 208 to review. The checklist 404, in some examples will include check items 412 which identify specific warnings, cautions or reminders relevant to the characteristic of the patient, these items include, but are not exclusively limited to:
allergies concerning the medication and the patient;
reactions with other medications that are currently being consumed by the patients;
the level of interaction that is possible between the medication prescribed and existing medication;
advice relating to the function of the medication and positive effects and benefits to the patient;
the possible side effects for the patient and the probability in which they will occur;
the interaction of this medication with food and the correct procedure in taking the medication;
the interaction of this medication with alcohol;
the dosage of this medication for the specific patient with each attribute of the patient (e.g. age, weight or gender or condition);
the duration of the consumption of the medication; and
the consideration of lifestyle factors for the patient that may be relevant for the prescription of medication.

Once the pharmacist has reviewed the checklist 404, the pharmacist 208 is then able to begin the consultation with the patient 206. This is usually done by consulting the patient 206 over each item 412 of the checklist 404. In some examples, this is done in person. However the interface 202 can be implemented to allow the consultation to be conducted over a computer network, telephone network or Internet. Once each item 412 has been consulted with the patient 206, the pharmacist 208 can interact with the interface 202 to indicate that the check item 412 has been addressed with the patient 206 and this indication can be written back into the database 120 for audit or verification purposes. The pharmacist 208 can also elect through the interface 202 for the server to print or otherwise deliver a copy of the checklist to the patient or other medical authority so that the patient 206 can be given some printed information about their prescribed medication.

In some embodiments, the checklist can be updated whereupon a patient 206, during the consultation process, provides additional information which may affect the consumption of the medication. If a patient reveals additional attributes, including medical condition or other attributes, the pharmacist 208 can enter these additional attributes into the interface 202 through a series of entry fields similar to the input boxes to receive patient details from a patient 206 as described above. The additional information entered into the interface will then be utilized by the processor to execute a query on the database 120 to retrieve any additional data associated with the medication that may be relevant to this new information. Depending on the result of this query, the processor will initiate an update process similar to the checklist generation process abovementioned to identify any associations between the further information submitted and the properties of the medication. Once these associations have been identified the checklist 404 is updated by the process, and the check items 412 are regenerated. The checklist 404 is then updated on the interface 202 for the pharmacist 208 to continue the consultation. In circumstances where a check item 412 has already been flagged as “consulted” by the pharmacist 208, but was updated due to the new information submitted, the check item will be flagged as “changed” and the pharmacist will be required to consult the patient 206 over the check item 412 again.

This embodiment is advantageous for the pharmacist 208 and the patient 206 as the patient may not have revealed relevant information about their condition or other characteristics at the first instance. This will affect the quality of the consultation between the pharmacist 208 and the patient 206 as important information describing the characteristics of the patient may not have been considered. Accordingly the checklist 404 can be further enhanced by updating the check items 412 during the consultation to ensure the further information can be processed and considered before the consultation is complete. For example, a patient intending to travel overseas may have been prescribed with a medication which requires refrigeration. As the consultation is conducted, the patient is told the proper handling of the medication and as a result, the patient suddenly discloses their travel plans and the fact that refrigeration of the medication would be impractical during their travels. The pharmacist is then able to make suggestions on possible alternatives such as a change in the course of the medication or suggest a different form of the medication (i.e. tablet form) based on the properties of the medication.

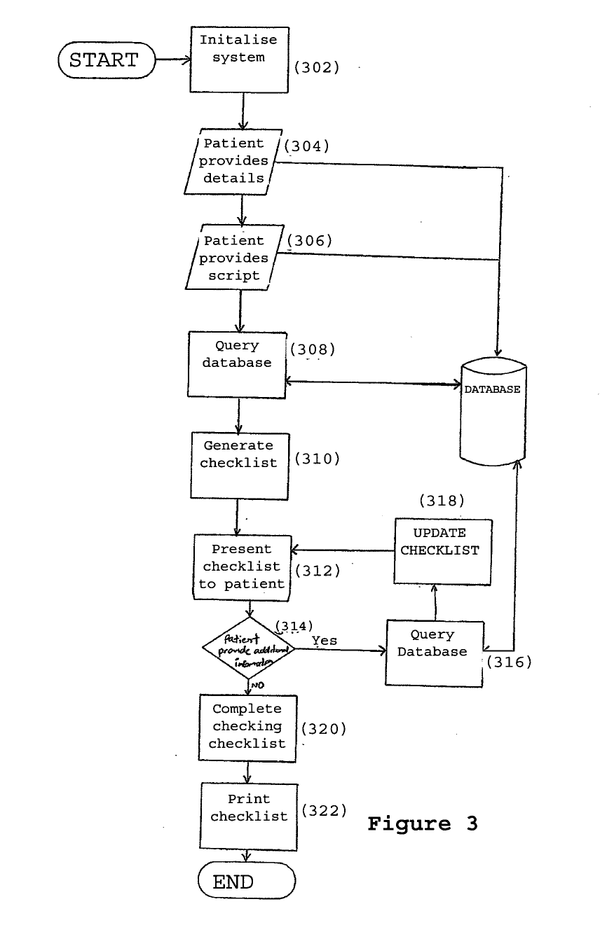

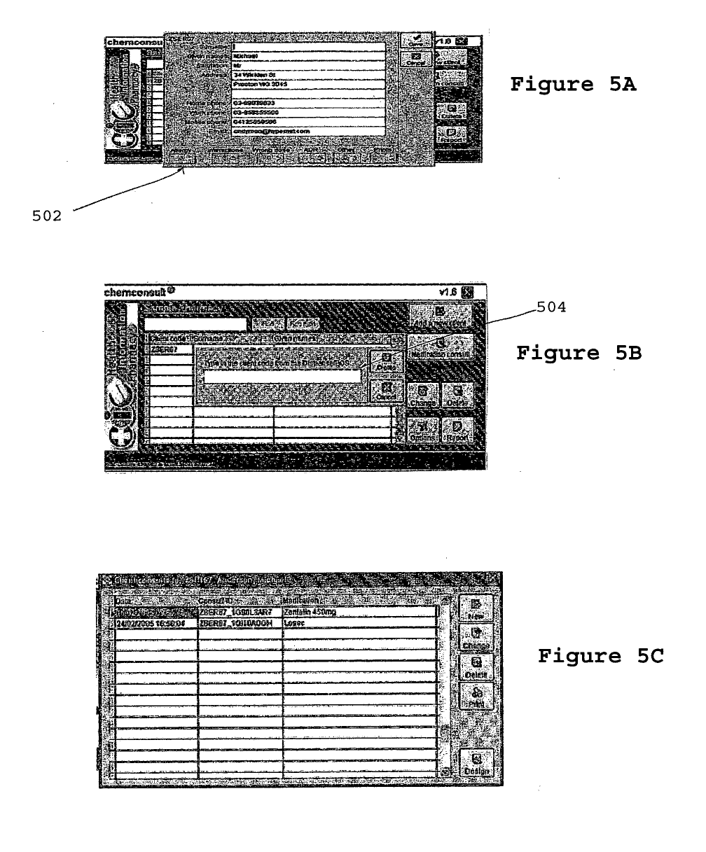

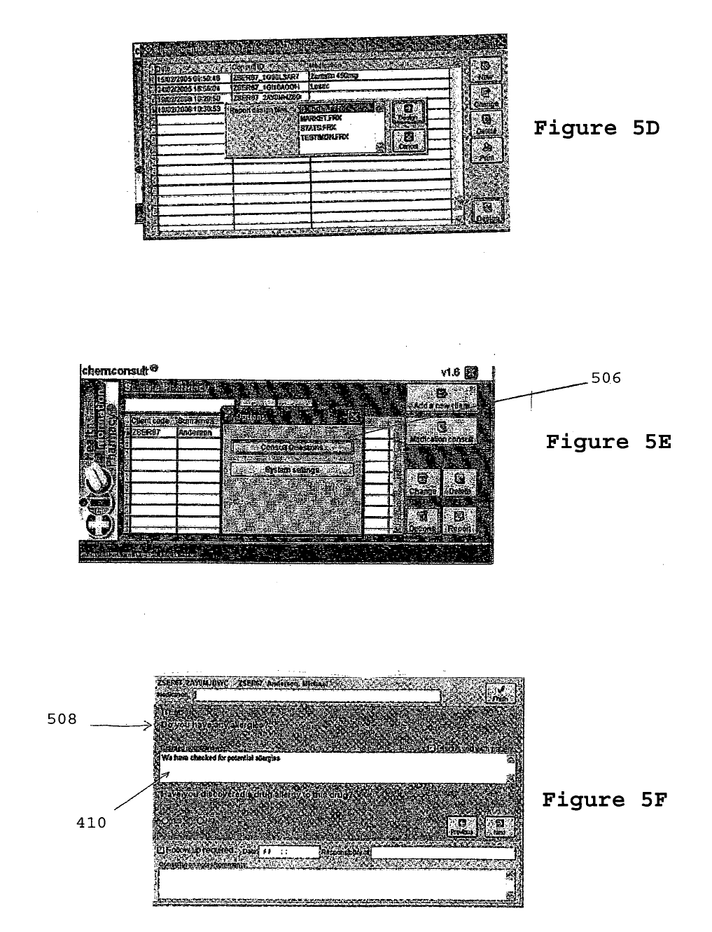

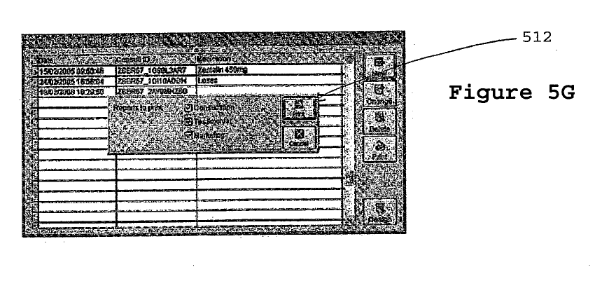

With reference to FIGS. 3 and 5A to 5G, the operation of an embodiment of the invention is illustrated by way of a flow chart as shown in FIG. 3 with specific example illustrations of screen shots of the interface 202 as shown in FIGS. 5A to 5G. As is shown in FIG. 3, the system is firstly initialised (302). This is done by establishing a connection between the server 100 and the database 120. As the data stored on the database 120 is potentially confidential the system may initiate a number of security checks to ensure the integrity of the connection between the server 100 and the database 120 is maintained.

After the system is initialised, the system will wait for a patient 206 to enter their details or provide their details to a pharmacist 208 who will enter these details into the interface. As is shown in FIG. 5A, there is provided a plurality of input boxes 502 for the patient details to be entered into the interface. In some examples, the input boxes 502 are populated automatically by a scanner device arranged to read a computer coded media such as a smart card or a barcode possessed by the patient, or in certain embodiments, where the patient details are already stored in the database, the input boxes 502 are automatically populated by retrieving the patient details from the database 120.

In this example, the patient 206 is required to provide a medication prescription in order to proceed with the consultation. This is to minimise the chance of error and the opportunities for prescription drugs abuse. Each medication prescription has a validation code which can be used to validate the authenticity of the prescription. In order for the consultation to proceed, the validation code is entered through a code request box 504 as shown in FIG. 5B. Once this code has been entered, a validation request is placed with a government authority through a secured connection with a government server. In this example, the code is sent to the server and the server 100 then listens for an acknowledgement of authenticity. During this process, an identifier for the medication prescribed as well as the dosage and form of the medication is also retrieved and entered into the interface 202, a screenshot showing this process is illustrated at FIG. 5C (306).

Once the interface 202 has both the identifier for the medication and the patient details, the server 100 will initiate the processor to trigger a query with the database (308). Following this, a checklist 404 is generated (310) by the checklist generation process which utilizes the data retrieved from the database 120 and the patient attributes retrieved. The checklist 404 is then displayed on the interface 202 and allows the pharmacist 208 to check off each item 412 of the checklist 404 with the patient during the consultation (312). In this example, to initiate the consultation, the pharmacist 208 can select a consultation tab 506 which displays the checklist 404 on the interface.

During the consultation, the pharmacist 208 will continue to update the checklist 404 with a confirmation that an individual checklist item 412 has been checked. Where the item may probe the patient for further information 508, the pharmacist can enter in additional information if the patient provides further information through a feedback box 410. This information is then executed by an update checklist process which will query the database 120 with this new information, and if applicable, update the checklist 404.

Once the pharmacist has checked off the entire checklist 404, the consultation will end, and the checklist 404 can be printed 512 or delivered to the patient for future reference. The printing process can be executed by the processor on the server 100, which will communicate with a printer device or other communication port such as an email server. Any information that was retrieved from the patient, or any added items from the pharmacist and the checklist 404 is then stored onto the system for future reference or auditing purposes.

In alternative embodiments, the system acts as a gateway for an external party, such as a pharmaceutical company or government body to access the information in the database 120. As the patient details are updated each time the patient 206 undertakes a consultation process with the pharmacist 208, additional data relating to the medication prescribed, including any affects the patient may have experienced with prior medications, as well as patient attributes and characteristics of any individual patient is stored within the database 120.

In these embodiments, the system has a business rule module arranged to restrict access of the database to each external third party in order to ensure private patient details are not freely disclosed.

This data can be utilised by authorized bodies for data mining or information analysis procedures and the information stored in the database will be particularly useful for pharmaceutical corporations as well as government bodies in assessing public health or affects of any particular medication with a plurality of patients.

In a further embodiment, the checklist generation process is able to utilise the data stored in the database to increase its accuracy in the generation of the checklist 404. If a pharmacist 208 identifies a certain important check item 412 is missing from a checklist 404 during a consultation process, the pharmacist 208 can insert the missing check item into the interface 202, which on the completion of the consultation, the interface 202 will record all of the data associated with the consultation, including the medication properties, the patient characteristics and the changes put in by the pharmacist into the database 120. In one example, this is done by generating metadata fields with metadata for a specific medication. By associating the extra metadata, subsequent execution of the checklist generation process by the processor will identify these new associations between the medication and any particular patient attribute, and thereby increasing the accuracy of a subsequent checklist 404 by incorporating a new check item 412 based on the new association.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files the skilled person assisting in the performance of particular functions, will understand that the functionality of the software application may be distributed across a number of routines, objects or components to achieve the same functionality.

It will also be appreciated that the methods and systems of the present invention are implemented by computing system or partly implemented by computing systems than any appropriate computing system architecture may be utilised. This will include stand alone computers, network computers and dedicated computing devices. Where the terms “computing system” and “computing device” are used, these terms are intended to cover any appropriate 2D arrangement of computer hardware for implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for providing information regarding a medication comprising the steps of, retrieving data associated with the medication, generating a checklist on the basis of the retrieved data, wherein the checklist is arranged with at least one item for checking with a patient.

2. A method in accordance with claim 1, comprising the further step of retrieving patient details before generating the checklist, the details disclosing at least one characteristic of the patient prescribed with the medication.

3. A method in accordance with claim 2, wherein the checklist is generated by comparing associations between the retrieved data and the patient details, the checklist having the at least one item arranged to provide information concerning the medication associated with the at least one characteristic of the patient.

4. A method in accordance with claim 2, further comprising the step of providing further information regarding the patient, wherein if the further information affects the consumption of the medication, the further information enables the checklist to be updated with further items for checking with the patient.

5. A method in accordance with claim 2, wherein each item is a warning or caution.

6. A method in accordance with claim 5, wherein the warning concerns a dosage of the medication.

7. A method in accordance with claim 5, wherein the warning concerns at least one effect or interaction of the medication.

8. A method in accordance with claim 2, wherein the characteristic is an attribute of the patient.

9. A method in accordance with claim 8, wherein the attribute includes specific information regarding the patient.

10. A method in accordance with claim 8, wherein the attribute is one of age, gender, weight, race, demographic classification or medical condition.

11. A method for storing data in accordance with claim 1, comprising the steps of identifying at least one property of the medication from the retrieved data, identifying at least one attribute of the patient relating to the property of the medication, and associating each of the at least one property of the medication with each the at least one attribute of the patient.

12. A method in accordance with claim 11, wherein the data is stored at a remote location.

13. A method in accordance with claim 11, wherein the data is accessible to an external party.

14. A method in accordance with claim 1, further comprising the step of collecting feedback, the feedback being stored with the data to assist with the generation of the checklists.

15. A system for providing information regarding a medication comprising, a processor arranged to retrieve data associated with the medication, a routine arranged to generate a checklist on the basis of the retrieved data, wherein the checklist is arranged with at least one item for checking with a patient.

16. A system in accordance with claim 15, wherein the processor retrieves patient details before the routine generates the checklist, the patient details disclosing at least one characteristic of the patient prescribed with the medication.

17. A system in accordance with claim 16, wherein the routine generates the checklist by comparing associations between the retrieved data and the patient details, the checklist having the at least one item arranged to provide information concerning the medication associated with the at least one characteristic of the patient.

18. A system in accordance with claim 16, further comprising a module arranged to provide further information regarding the patient, wherein if the further information affects the consumption of the medication, the further information enables the checklist to be updated with further items for checking with the patient.

19. A system in accordance with claim 16, wherein each item is a warning or caution.

20. A system in accordance with claim 19, wherein the warning concerns a dosage of the medication.

21. A system in accordance with claim 19, wherein the warning concerns at least one effect or interaction of the medication.

22. A system in accordance with claim 20, wherein the characteristic is an attribute of the patient.

23. A system in accordance with claim 22, wherein the attribute includes specific information regarding the patient.

24. A system in accordance with claim 22, wherein the attribute is one of age, gender, weight, race, demographic classification or medical condition.

25. A system for storing data in accordance with claim 11, comprising a module for identifying at least one property of the medication from the retrieved data, identifying at least one attribute of the patient relating to the property of the medication, and associating each of the at least one property of the medication with each the at least one attribute of the patient.

26. A system in accordance with claim 11, wherein the data is stored at a remote location.

27. A system in accordance with claim 11, wherein the data is accessible to an external party.

28. A system in accordance with claim 1, further comprising a routine arranged to collect feedback, the feedback being stored with the data to assist with the generation of the checklists.

29-30. (canceled)
